(19) United States
(12) Patent Application Publication
(10) Pub. No.: US 2021/0060645 A1
(43) Pub. Date: Mar. 4, 2021

(54) Laser Sintering 3D Printing Thermal Compensation System and Method

(71) Applicant: AIC RD Tech Co., Ltd., Taipei City 100 (TW)

(72) Inventor: Yi-Ming Jian, Taipei City (TW)

(21) Appl. No.: 16/558,385

(22) Filed: Sep. 3, 2019

(51) Int. Cl. B22F 3/105; B33Y 10/00; B33Y 30/00; B33Y 50/02; B29C 64/153; B29C 64/268; B29C 64/277; B29C 64/393

(52) U.S. Cl. CPC B22F 3/1055; B33Y 10/00; B33Y 30/00; B33Y 50/02; B22F 2003/1057; B29C 64/268; B29C 64/277; B29C 64/393; B29C 64/153

(57) ABSTRACT

A laser sintering 3D printing thermal compensation system is provided and includes a controller and a heating device and a temperature field sensing device respectively connected to the controller, in which the temperature field sensing device is configured to determine a detection result by detecting within a printing region, the detection result includes a high temperature region and a relatively low-temperature region, and the controller is configured to control the heating device to heat the relatively low-temperature region for conducting thermal compensation, thereby reducing the temperature difference between the high temperature region and the relatively low-temperature region, and overcoming drawbacks of conventional arts having inaccurate control of the temperature field, causing interface defects due to temperature unevenness, and, consequently, greatly reducing the printing quality.

### FIELD OF THE INVENTION

The present invention relates to a laser sintering 3D printing manner, and more particularly to a system and method for laser sintering 3D printing thermal compensation.

### BACKGROUND OF THE INVENTION

Conventional Laser Sintering 3D printing (Selective Laser Sintering; SLS/Selective Laser Melting; SLM) is to respectively sinter and cure the uppermost metal or polymer powder layer layer-by-layer by high power lasers, so that the printed product can be gradually formed while repeatedly curing and sintering the powder layers. The unsintered powder of the powder layers play a role of supporting the printing of the intermediate product during the 3D printing process, and the unsintered portion can be finally removed while the printed product is formed and the printing process is completed.

The aforementioned laser sintering 3D printing is conventionally performed by a few steps including selectively sintering a portion of a powder layer by a high power laser scanning device, covering another powder layer on the powder layer having the sintered portion, sintering and solidifying, by the laser scanning device, a portion of the uppermost powder layer, and then covering it with another powder layer. By repeatedly performing the above cycle of sintering, solidifying of the powder layers and covering with another powder layer thereon, the laser sintering 3D printing can then be completed. However, due to the residual temperature of the sintered portion after scanning by the laser scanning device, the temperature of the temperature field scanned by the laser scanning device is uneven, thereby easily causing interface defects and affecting sintering and solidifying processes to the powder layers, and eventually reducing the quality of the 3D printed product.

### SUMMARY OF THE INVENTION

Due to the uneven temperature field temperature of powder layers during the operation of conventional laser sintering 3D (three-dimensional) printers, the printing result is not ideal. Accordingly, the present invention provides a manner for conducting thermal compensation by heating the powder layers, thereby achieving the result of increasing the temperature field temperature of the powder layers, thereby improving the printing quality of laser sintering 3D printers. In order to achieve the above purpose, a laser sintered 3D printing thermal compensation system is provided.

In order to achieve the foregoing purpose, a laser sintering 3D printing thermal compensation system is provided and includes a controller, and a heating device and a temperature field sensing device respectively connected to the controller, in which the temperature field sensing device is configured to determine a detection result by detecting within a printing region, the detection result includes a high temperature region and a relatively low-temperature region, and the controller is configured to control the heating device to heat the relatively low-temperature region for conducting thermal compensation, thereby reducing the temperature difference between the high temperature region and the relatively low-temperature region.

In order to achieve the foregoing purpose, the laser sintering 3D printing thermal compensation system of the present invention includes a powder layer disposed on the printing region, a part of the powder layer is sintered to form a sintered bed, a surface powder layer is covered on the powder layer; a heating device is also included corresponding to the printing region, and the heating device is configured to heat a part of the surface powder layer not covering the sintered bed for thermal compensation, thereby making the temperature field temperature of the surface powder layer more evenly.

In order to achieve the foregoing purpose, a laser sintering 3D printing thermal compensation method utilizing the laser sintering 3D printing thermal compensation system is provided and includes the following steps:

a) powder layer sintering step: covering the printing region with a powder layer, sintering a part of the powder layer into a sintered bed by utilizing a laser module, wherein the temperature of the sintered bed is higher than the other part of the powder layer;

b) surface powder layer covering step: covering the surface powder layer on the powder layer; and

c) sintered bed thermal compensation step: acquiring a temperature detecting result of the printing region by the temperature field sensing device, heating the relatively low-temperature region for thermal compensation, thereby reducing the temperature difference between the high temperature region and the relatively low-temperature region, wherein the relatively low-temperature region is the part of the surface powder layer not covering the sintered bed.

In order to achieve the foregoing purpose, a laser sintering 3D printing thermal compensation method is provided and includes the following steps:

a) powder layer sintering step: covering the printing region with a powder layer, sintering a part of the powder layer into a sintered bed by utilizing a laser module, wherein the temperature of the sintered bed is higher than the other part of the powder layer;

b) surface powder layer covering step: covering the surface powder layer on the powder layer; and

c) sintered bed thermal compensation step: heating the part of the surface powder layer not covering the sintered bed by a heating device for thermal compensation, thereby making the temperature field temperature of the surface powder layer more evenly.

The present invention reduces the temperature difference between the high temperature region and the relatively low-temperature region by providing a heat source to the relatively low-temperature region within the printing region from the heating device, thereby preventing interface defects during laser sintering 3D printing, and greatly enhancing the laser 3D printing result performed by the laser 3D printer to the surface powder layer.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic diagram illustrating a first preferred embodiment of the present invention mounted on a laser sintering 3D printer.

FIG. 2 is a schematic diagram illustrating an operation process of the first preferred embodiment of the present invention mounted on the laser sintering 3D printer.

FIG. 3 is a block diagram illustrating the first preferred embodiment of the present invention mounted on the laser sintering 3D printer.

FIG. 4 is a schematic diagram illustrating an operation process of a second preferred embodiment of the present invention mounted on a laser sintering 3D printer.

FIG. 5 is a schematic diagram illustrating an operation process of a third preferred embodiment of the present invention mounted on a laser sintering 3D printer.

FIG. 6 is a flow chart illustrating a method of a preferred embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method or the system by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that when an element is referred to as being “connected” to another element, it can be directly connected to the other element or intervening elements may be present.

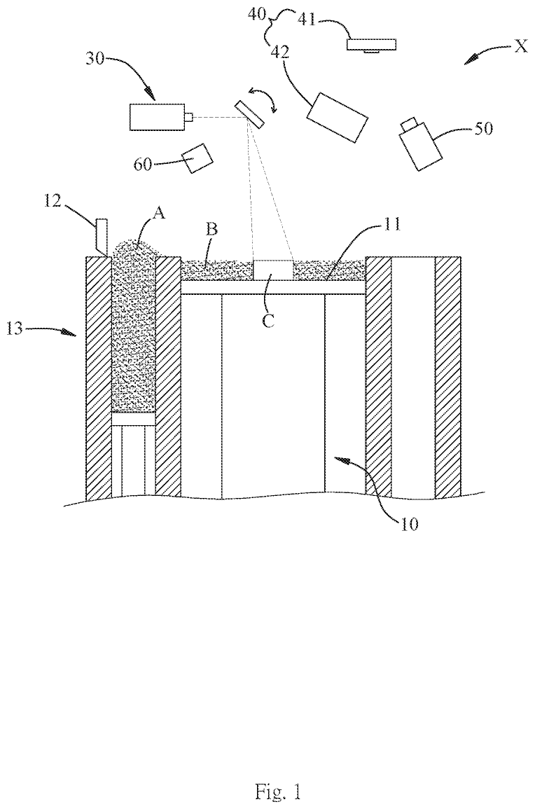

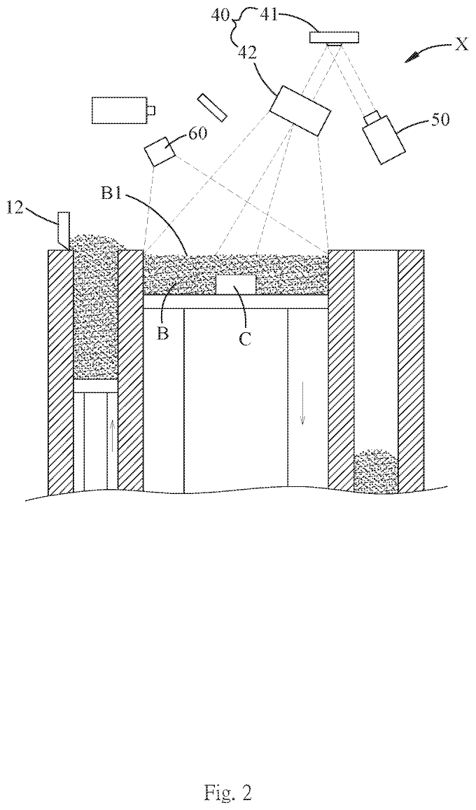

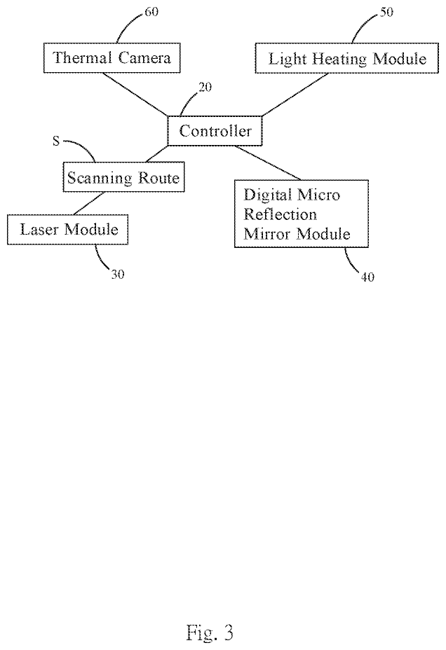

FIG. 1 to FIG. 3 illustrate a first preferred embodiment of the present invention, in which a laser sintering 3D printing temperature compensation system is provided and is adapted to be mounted on a laser sintering 3D printer, the structure after mounting includes a printing platform 10, a controller 20, and a laser module 30, a digital micro reflection mirror module 40, a light heating module 50, and a thermal camera 60 that are respectively electrically connected to the controller 20, in which:

A top part of the printing platform 10 has a printing region 11, aside of the printing region has a scraper unit 12 and a powder case 13 containing powder A to be sintered, and the powder A can be such as metallic powders or polymer powders, the scraper unit 12 is capable of flattening the powder A to form a powder layer B on the printing region 11, and the printing region 11 is gradually lowered every time the printing region 11 is covered by a powder layer B.

The laser module 30 is disposed above the printing region 11, the laser module 30 is controlled by the controller 20 to apply high-power laser to the printing region 11 along a scanning route S, and a part of the powder layer B is sintered forming a sintered bed C. While the part of the powder layer B has turned into the sintered bed C, the printing region 11 is lowered and the powder A in the powder case 13 is flattened by the scraper unit 12 again to form a surface powder layer B1 above the powder layer B. Note that the uppermost of the powder layer B is named as the surface powder layer B1 during the process according to the preferred embodiment of the present invention.

The digital micro reflection mirror module 40 is disposed above the printing region 11 and includes a digital micromirror device (DMD) 41, the digital micromirror device 41 has hundreds of thousands of microlenses in order to selectively reflecting lights from a light source to and within the scope of the printing region 11.

Furthermore, the digital micro reflection mirror module 40 includes a projection lens 42, the projection lens 42 is located between the printing region 11 and the digital micromirror device 41, the light beams selectively reflected by the digital micromirror device 41 are projected onto the printing region 11 through the projection lens 42.

The direction of light from the light heating module 50 is emitted toward the digital micromirror device 41 of the digital micro reflection mirror module 40, and a combination of the light heating module 50 and the digital micro reflection mirror module 40 can be called a heating device X. The light heating module 50 may emit either laser beam having power lower than the sintering power of the powder layer B, or regular thermal radiation lights for thermal compensation. The controller 20 controls the digital micromirror device 41 to selectively reflect the light emitted from the light heating module 50 to the printing region 11 to heat-up a portion of the surface powder layer B1 that is not covering the sintered bed C for thermal compensation.

The thermal camera 60 is utilized as a thermal sensing device for detecting and determining whether the temperature of the temperature field of the surface powder layer B1 formed on the printing region 11 is even, and then sending back a detection result to the controller 20. The detection result indicates a high-temperature region and a relatively low-temperature region. The temperature of the portion of the surface powder layer B1 that is covering or in contact with the sintered bed C increases due to the heat remaining on the sintered bed C, and that portion is called the high-temperature region. According to the detection result indicating the uniformity of the temperature field temperature detected by the thermal camera 60, the controller 20 controls the digital micromirror device 41 to selectively reflect light source to heat-up the relatively low-temperature region of the surface powder layer B1 that is not cover by the sintered bed C for thermal compensation, thereby reducing the temperature difference between the high temperature region and the relatively low-temperature region, so as to make the temperature of the uppermost surface powder layer B1 more uniform. Then, the controller 20 further controls the laser module 30 to sinter a portion of the uppermost surface powder layer B1, and by repeating the foregoing cycle of sintering the sintered bed C from each powder layer B and covering with another surface powder layer B1 thereafter, a laser sintering 3D printing process can be completed. As a result, the temperature field during 3D printing can be precisely controlled, so as to prevent any interface defect and thereby significantly improving the printing quality.

In addition to the foregoing first preferred embodiment that utilizes the thermal camera 60 to detect and feedback the temperature field temperature of the surface powder layer B1 to the controller 20 for controlling the digital micromirror device 41 to selectively reflect the light source to heat the portion of the surface powder layer B1 that is not covering each of the sintered bed C according to the detection result from the thermal camera 60, a non-contact temperature sensor such as an infrared temperature sensor can be utilized as a temperature field sensing device as well. Alternatively, the controller 20 may also be utilized to read the scanning route S of the laser module 30 that scans and sinters to form the sintered bed C, and to conduct thermal compensation by selectively reflecting the light source to the surface powder layer B1 that is not covering the sintered bed C by the digital micromirror device 41 in a manner avoiding the scanning route S. By conducting thermal compensation to the surface powder layer B1 in a manner of avoiding the scanning route S, the use of the thermal camera 60 can be omitted, or, alternatively, both manners can be used at the same time to enhance efficiency and precision.

In addition to the foregoing first preferred embodiment that utilizes the digital micromirror device 41 to reflect the light source of the light heating module 50 to be the heating device X, a laser scanning device 70 adapted to be installed on the laser sintering 3D printer, or the aforementioned laser module 30, can also be used as the heating device X as depicted in the following second and third preferred embodiments.

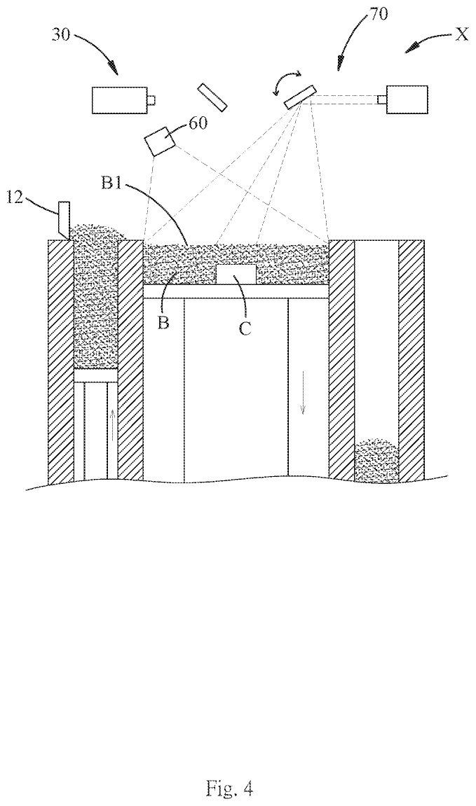

Referring to FIG. 4 illustrating the second preferred embodiment of the present invention, the low-power laser scanning device 70, namely the heating device in this embodiment, utilized for thermal compensation is disposed above the printing region 11, where the laser scanning device 70 is configured to heat the portion of the surface powder layer B1 not covering the sintered bed C for thermal compensation. The aforementioned low-power laser scanning device 70 means that the power of which is relatively lower than the high power of the laser module 30, and the sintered bed C is formed by the scanning of the high-power laser module 30.

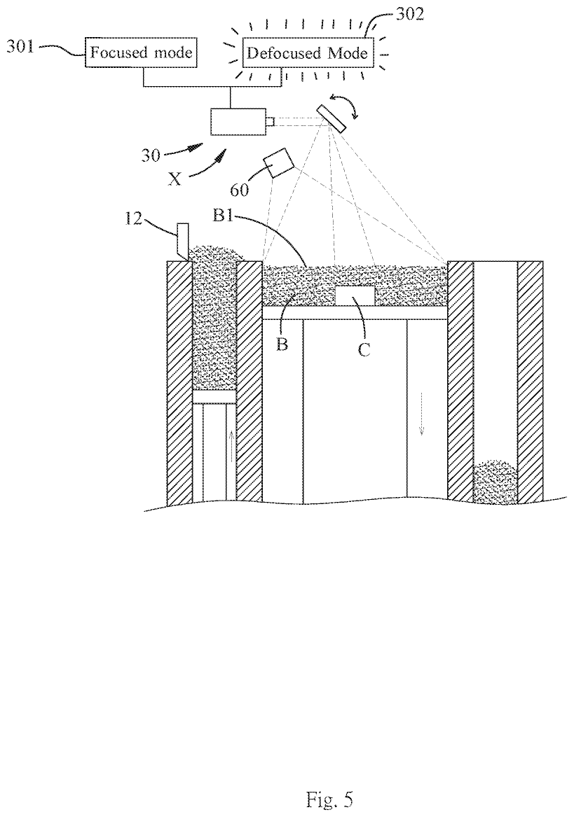

Referring to FIG. 5 illustrating the third preferred embodiment, in this embodiment, the heating device X is the laser module 30 of the laser sintering 3D printer, in which the laser module 30 can be operated under a high-power focused mode 301 and a lower-power defocused mode 302; the sintered bed C is formed by scanning with the laser module 30 under the high-power focused mode 301, whereas the low-power defocused mode 302 is utilized for thermal compensation by heating the surface powder layer B1 not covering the sintered bed C.

The foregoing temperature compensation can be utilized to overcome drawbacks of conventional arts having imprecise control of the temperature field, causing interface defects due to temperature unevenness, and, consequently, greatly reducing the printing quality.

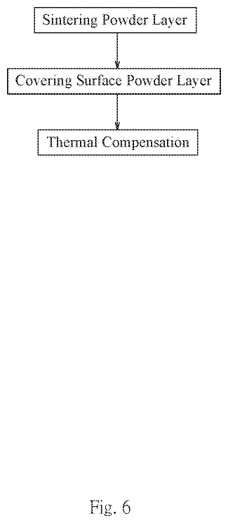

A laser sintering 3D printing thermal compensation method according to another preferred embodiment of the present invention is further provided, referring to the flow chart illustrated in FIG. 6, and FIG. 1 to FIG. 3, the method includes:

Sintering powder layer: covering the printing region 11 on the top surface of the printing platform 10 with a powder layer B by utilizing the scraper unit 12, sintering a part of the powder layer B into a sintered bed C by utilizing the laser module 30 electrically connected to the controller 20, in which the temperature of the sintered bed C is higher than the other part of the powder layer B.

Covering with surface powder layer: subsequently lowering the printing region 11, and covering a surface powder layer B1 on the powder layer B including the sintered bed C by utilizing the scraper unit 12, in which the temperature of the bottom part of the surface powder layer B1 in contact with the sintered bed C increases due to the residual temperature of the sintered bed C.

Thermal compensation: the controller 20 controlling the heating device X driving the digital micro reflection mirror 40 to reflect the laser beam or thermal radiation light from the light heating module 50 to the part of the surface powder layer B1 that is not covering the sintered bed C, thereby conducting thermal compensation to heat the part of the surface powder layer B1 not covering the sintered bed C.

During the step of thermal compensation of the foregoing thermal compensation method, the temperature field temperature of the surface powder layer B1 can be detected by the thermal camera 60 electrically connected to the controller 20, so as to feedback temperature uniformity results of the surface powder layer B1 to the controller, thereby making the temperature of the surface powder layer B1 to be more even while conducting thermal compensation.

During the step of thermal compensation of the foregoing thermal compensation method, the controller 20 reads the scanning route S of where the laser module 30 sinters the sintered bed C, so that the heating device X can be driven to conduct thermal compensation to the part of the surface powder layer B1 that is not covering the sintered C in a manner avoiding the scanning route S.

In addition to the foregoing first preferred embodiment that utilizes the digital micro reflection mirror module 40 and the light heating module 50 to be the heating device X, the heating device X depicted in the second preferred embodiment or the third preferred embodiment may also be used as a heat source for thermally compensating the part of the surface powder layer B1 not contacting the sintered portion C. The use of the heating device X of the present invention is not limited to the above preferred embodiments as long as it can be used for scanning heating or heating the entire surface of the surface powder layer B1 not contacting the sintered portion C.

The description of the invention including its applications and advantages as set forth herein is illustrative and is not intended to limit the scope of the invention, which is set forth in the claims Variations and modifications of the embodiments disclosed herein are possible, and practical alternatives to and equivalents of the various elements of the embodiments would be understood to those of ordinary skill in the art upon study of this patent document. For example, specific values given herein are illustrative unless identified as being otherwise, and may be varied as a matter of design consideration. Terms such as “target” and “background” or so are distinguishing terms and are not to be construed to imply an order or a specific part of the whole. These and other variations and modifications of the embodiments disclosed herein, including of the alternatives and equivalents of the various elements of the embodiments, may be made without departing from the scope and spirit of the invention, including the invention as set forth in the following claims

What is claimed is:

1. A laser sintering 3D printing thermal compensation system, comprising a controller, and a heating device and a temperature field sensing device respectively connected to the controller, wherein the temperature field sensing device is configured to determine a detection result by detecting within a printing region, the detection result includes a high temperature region and a relatively low-temperature region, and the controller is configured to control the heating device to heat the relatively low-temperature region for conducting thermal compensation, thereby reducing the temperature difference between the high temperature region and the relatively low-temperature region.

2. The laser sintering 3D printing thermal compensation system as claimed in claim 1, wherein the heating device is a laser module, the laser module is selectively operated in a high power focused mode or a low power defocused mode, and the laser module is configured to conduct heat compensation to the relatively low-temperature region by operating in the defocused mode.

3. The laser sintering 3D printing thermal compensation system as claimed in claim 1, wherein the heating device includes a digital micro reflection mirror module and a light heating module respectively electrically connected to the controller, the light heating module faces the digital micro reflection mirror module, and the controller is configured to drive the digital micro reflection module to selectively reflect light from the light heating module to provide thermal compensation.

4. The laser sintering 3D printing thermal compensation system as claimed in claim 3, wherein the digital micro reflection mirror module includes a digital micromirror device and a projection lens, the light heating module faces the digital micromirror device, and the light reflected by the digital micromirror device selectively passes through the projection lens to the printing region for providing thermal compensation.

5. The laser sintering 3D printing thermal compensation system as claimed in claim 1, wherein a powder layer is disposed on the printing region, a part of the powder layer is sintered to form a sintered bed, a surface powder layer is covered on the powder layer, a part of the surface powder layer that covers the sintered bed is the high temperature region, and the other part of the surface powder layer not covering the sintered bed is the relatively low-temperature region.

6. The laser sintering 3D printing thermal compensation system as claimed in claim 5, wherein the sintered bed is sintered by scanning with a high power laser module, and the heating device is a lower power laser scanning device.

7. The laser sintering 3D printing thermal compensation system as claimed in claim 5, wherein the heating device is a laser module, the laser module is selectively operated in a high power focused mode or a low power defocused mode, and the laser module is configured to conduct heat compensation to the relatively low-temperature region by operating in the defocused mode.

8. The laser sintering 3D printing thermal compensation system as claimed in claim 5, wherein the heating device includes a digital micro reflection mirror module and a light heating module respectively electrically connected to the controller, the light heating module faces the digital micro reflection mirror module, the controller is configured to drive the digital micro reflection module to selectively reflect light from the light heating module to provide thermal compensation.

9. The laser sintering 3D printing thermal compensation system as claimed in claim 8, wherein the digital micro reflection mirror module includes a digital micromirror device and a projection lens, the light heating module faces the digital micromirror device, and the light reflected by the digital micromirror device selectively passes through the projection lens to the printing region for providing thermal compensation.
The laser sintering 3D printing thermal compensation system as claimed in claim 1, wherein the temperature field sensing device is a thermal camera electrically connected to the controller, the thermal camera is configured to detect the temperature field temperature of the surface powder layer, and feedback a result to the controller.

10. The laser sintering 3D printing thermal compensation system as claimed in claim 10, wherein the sintered bed is sintered by scanning with a high power laser module, and the heating device is a lower power laser scanning device.

11. The laser sintering 3D printing thermal compensation system as claimed in claim 10, wherein the heating device is a laser module, the laser module is selectively operated in a high power focused mode or a low power defocused mode, and the laser module is configured to conduct heat compensation to the relatively low-temperature region by operating in the defocused mode.

12. The laser sintering 3D printing thermal compensation system as claimed in claim 10, wherein the heating device includes a digital micro reflection mirror module and a light heating module respectively electrically connected to the controller, the light heating module faces the digital micro reflection mirror module, the controller is configured to drive the digital micro reflection module to selectively reflect light from the light heating module to provide thermal compensation.

13. The laser sintering 3D printing thermal compensation system as claimed in claim 1, wherein the temperature field sensing device is an infrared temperature detector electrically connected to the controller, and the infrared temperature detector is configured to detect the temperature field temperature of the surface powder layer and feedback a result to the controller.

14. The laser sintering 3D printing thermal compensation system as claimed in claim 14, wherein the sintered bed is sintered by scanning with a high power laser module, and the heating device is a lower power laser scanning device.

15. The laser sintering 3D printing thermal compensation system as claimed in claim 14, wherein the heating device is a laser module, the laser module is selectively operated in a high power focused mode or a low power defocused mode, and the laser module is configured to conduct heat compensation to the relatively low-temperature region by operating in the defocused mode.

16. The laser sintering 3D printing thermal compensation system as claimed in claim 14, wherein the heating device includes a digital micro reflection mirror module and a light heating module respectively electrically connected to the controller, the light heating module faces the digital micro reflection mirror module, the controller is configured to drive the digital micro reflection module to selectively reflect light from the light heating module to provide thermal compensation

17. The laser sintering 3D printing thermal compensation system as claimed in claim 17, wherein the digital micro reflection mirror module includes a digital micromirror device and a projection lens, the light heating module faces the digital micromirror device, and the light reflected by the digital micromirror device selectively passes through the projection lens to the printing region for providing thermal compensation.

18. A laser sintering 3D printing thermal compensation method utilizing the laser sintering 3D printing thermal compensation system as claims in claim 1, comprising the following steps:
a) powder layer sintering step: covering the printing region with a powder layer, sintering a part of the powder layer into a sintered bed by utilizing a laser module, wherein the temperature of the sintered bed is higher than the other part of the powder layer;
b) surface powder layer covering step: covering the surface powder layer on the powder layer; and
c) sintered bed thermal compensation step: acquiring a temperature detecting result of the printing region by the temperature field sensing device, heating the relatively low-temperature region for thermal compensation, thereby reducing the temperature difference between the high temperature region and the relatively low-temperature region, wherein the relatively low-temperature region is the part of the surface powder layer not covering the sintered bed.

19. The laser sintering 3D printing thermal compensation method as claimed in claim 19, wherein in the sintered bed thermal compensation step, the temperature field sensing device is a thermal camera or an infrared temperature detector.
